(19) United States
(12) Patent Application Publication
(10) Pub. No.: US 2010/0143809 A1
(43) Pub. Date: Jun. 10, 2010

(54) Air Bleed Through Fuel Cell Fuel Recycle Loop

(76) Inventors: Michael L. Perry, South Glastonbury, CT (US); Craig E. Evans, Manchester, CT (US)

Correspondence Address: M.P. Williams, 210 Main Street, Manchester, CT, 06042, US

(21) Appl. No.: 12/087,035

(22) PCT Filed: Dec. 30, 2005
(86) PCT No.: PCT/US05/47573

§ 371 Date: Jun. 24, 2008

(51) Int. Cl. H01M 8/06

(52) U.S. Cl. 429/415

(57) ABSTRACT

In a fuel cell power plant (9) air bleed is provided to the anode flow fields (13) of a stack (11) of fuel cells by introducing the air into the recycle loop (23, 24) upstream of the recycle drive (25). The source of air may be the cathode air supply device (31) that provides oxidant reactant gas to the cathode flow fields (14), or a separate, low pressure, low flow air pump (48) or a separate low pressure, low flow pump (45) connected from the cathode air supply devise (31) through flow controllers (41, 42) to the pressure side of the recycle loop (23, 24) at the exhaust of the anode flow fields (13).

### TECHNICAL FIELD

This invention relates to injecting air in the anode flow fields of a proton exchange membrane (PEM) by mixing it with fuel recycle gas, so as to convert carbon monoxide to carbon dioxide and thus reduce contamination and deterioration of the anode electrode catalyst, and consequent loss of performance.

### BACKGROUND ART

It is common practice to inject a small amount of air (an air bleed) into the anode reactant gas stream of PEM fuel cells. The air converts carbon monoxide, which is a poison to the anode electrode catalyst, to carbon dioxide, which is innocuous. An air-bleed may also help oxidize other contaminants that may be present in the fuel stream as well. Air-bleed systems have most typically been employed when operating a PEM fuel cell stack on reformate fuel, which has a relatively high concentration (on the order of 10 to 100 ppm) of CO even after conversion methods, such as preferential oxidation, are employed upstream of the fuel cell. A proper air-bleed system has to balance the amount of air in the anode, sufficient to provide a beneficial reduction of carbon monoxide, yet not exceed the combustibility limit with the hydrogen in the fuel supply. Air-bleed systems are therefore complicated and can result in undesirable system complexity as well as adverse safety conditions.

### DISCLOSURE OF INVENTION

Aspects of the invention include: a fuel cell system which readily tolerates low purity hydrogen; a safe fuel cell air-bleed system; a simple fuel cell anode air-bleed system; a simplified manner of reducing poisoning of fuel cell anode catalyst; improved fuel cell performance; extending fuel cell performance over long periods of time; and improved fuel cell and fuel cell operation.

High purity hydrogen, such as “laboratory-grade” hydrogen, is too expensive for day-to-day operation of fuel cell power plants. This invention recognizes that so-called “pure” hydrogen, such as “industrial-grade” hydrogen, typically contains carbon monoxide in excess of 5 ppm, or more, and other impurities such as sulfur and carbon dioxide (which may backshift to carbon monoxide). Therefore, an air-bleed is advantageous when using impure hydrogen (i.e., less than 99.999% H₂). The invention is also predicated on the fact that hydrogen-rich fuels (i.e., greater than 90% H₂) are advantageously recycled to maximize the utilization of the hydrogen.

This invention is predicated in part on the realization that the pressure and flow parameters in a fuel cell fuel-recycle loop are advantageous for introducing air bleed in a very simple fashion, to provide a small air bleed, and more particularly that the low fuel pressure in the fuel recycle loop (being so much lower than at the fuel inlet) enables using a side stream from the cathode air blower, or a dedicated air blower with a relatively low head and low flow requirement, or a combination of such blowers.

According to the present invention, a small amount of air is bled into the anode fuel-recycle loop gas stream. According further to the invention, a small amount of air from the cathode air supply is introduced into the fuel-recycle loop gas stream. In accordance further with the invention, air from a small, low pressure pump may be introduced into the fuel-recycle loop gas stream. In still further accord with the invention, the pressure of air taken from the cathode air supply pump is boosted slightly with a very small pump, the output of which is connected into the fuel-recycle loop gas stream.

The invention takes advantage of the pressure and flow relationships in a fuel-recycle loop, which are advantageous to introducing a small amount of air in an economical, safe and uncomplicated fashion.

The advantages of the inventive configuration herein over conventional air-bleed at the anode inlet are: lower pressure pumps and/or the elimination of dedicated air-bleed pump or eductor, better mixing of fuel and air before entering the anode flow fields; and the ability to control the pressure of the air-bleed.

Other aspects, features and advantages of the present invention will become more apparent in the light of the following detailed description of exemplary embodiments thereof, as illustrated in the accompanying drawing.

### BRIEF DESCRIPTION OF THE DRAWINGS

FIGS. 1-3 are simplified, stylized block diagrams of portions of fuel cell power plants providing air-bleed to the fuel recycle loop from a cathode air pump, a separate air pump fed by the cathode air pump, or a separate air pump fed by ambient air, respectively.

### MODE(S) FOR CARRYING OUT THE INVENTION

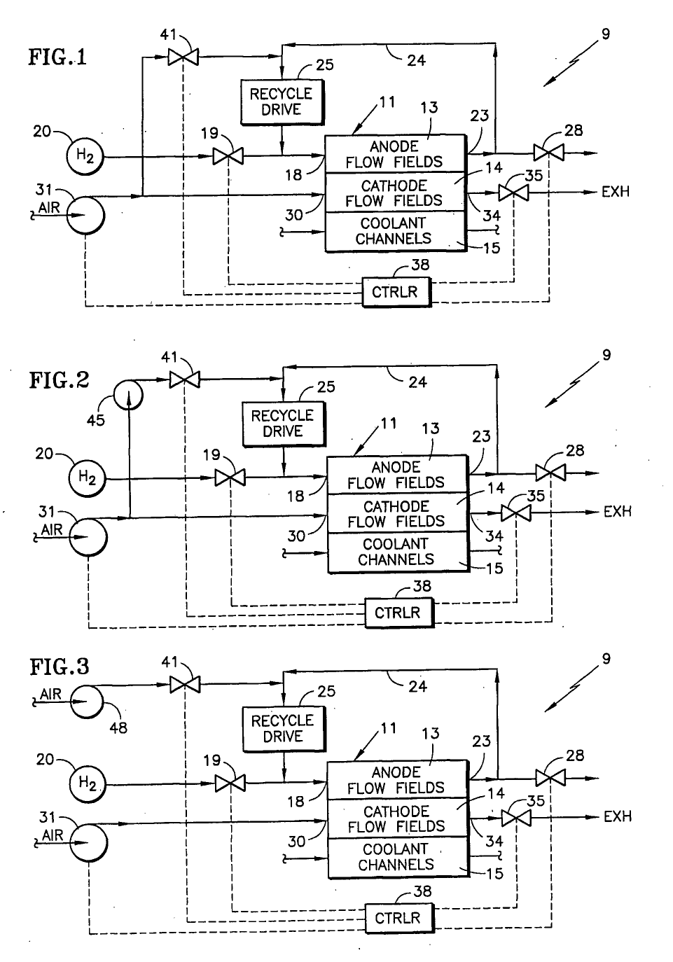

Referring to FIG. 1, a fuel cell power plant 9 includes a stack 11 of fuel cells, each of the fuel cells including anode flow fields 13, through which the fuel reactant gas flows, cathode flow fields 14, through which the oxidant reactant gas flows, and coolant channels 15, through which a coolant flows. An inlet 18 of the anode flow fields is connected through a pressure control valve 19 to a source 20 of hydrogen, which in the embodiments herein is deemed to be impure hydrogen. The outlet 23 of the anode flow fields is connected by a conduit 24 to a recycle drive 25, which may either be a conventional recycle pump, or a recycle eductor, driven by the fuel supply 20. The nature of the recycle drive is selectable to suit various implementations of the invention.

The outlets 23 of the anode flow fields 13 are also connected to a purge valve 28 through which a small amount of anode exhaust is continuously purged, or through which bursts of anode exhaust are exhausted to remove contaminants in the conventional fashion. The flow through the valve 28 may be vented, or may be sent to a burner (and related apparatus), or returned to the cathode flow fields, as may suit any implementation of the invention.

An inlet to the cathode flow fields 30 is connected to an air pump 31 and the outlet 34 from the cathode flow fields is connected through a pressure control valve 35 to exhaust (such as ambient). The valves 19, 28, 35 are responsive to a controller 38. If desired in any particular embodiment of the invention, particularly if the cathodes are run at near-ambient pressure, the valve 35 may be omitted; in either case, flow control may include control of the speed of the air blower 31 by the controller 38.

In accordance with a first embodiment of the invention, the recycle conduit 24 is connected through a flow restrictor, such as a flow control valve 41, to the outlet of the cathode air pump 31. The valve 41 is adjusted by the controller 38 so as to provide an air bleed into the anode of on the order of 0.25% to 1.0% (by volume). In this embodiment, there is no additional pump required. Because the pressure of the fuel recycle gas in the conduit 24 is much lower than the pressure at the anode inlet 18, the air bleed can be accomplished with low pressure, low flow devices, including the cathode air pump 31.

In the event that the pressure of the air pump 31 is not sufficient to provide an adequate flow of bleed air into the recycle loop, additional pressure may be provided by a very small pump 45 as is illustrated in FIG. 2. The advantage of this embodiment is that the pressure requirement of the pump 45 is reduced since the inlet pressure is provided by the cathode air pump 31. Additionally, this accommodates the fuel-exit pressure being greater than the air-inlet pressure, which may be desirable in many cases.

Another embodiment of the invention, illustrated in FIG. 3, does not use outflow of the cathode air pump 31, but uses a dedicated, low pressure, low flow pump 48 to provide air into the recycle loop. Because only a small volume percent of air is required (or tolerated for that matter), a low flow of air is sufficient. Since the recycle loop at the inlet to the recycle drive 25 is low pressure (on the order of a few kPa (a fraction of a psi) the pump can simply be a very low cost, low pressure, low flow blower.

If found to be desirable in any implementation of the present invention, the flow restrictor may include a fixed orifice placed in series with the valve 41, in any of the embodiments of FIGS. 1-3. In the embodiments of FIGS. 1 and 2, the control valve 41 may be replaced by a simple, fixed orifice or air flow restrictor that need not be controlled at all. This is because both the air bleed required and the cathode air flow increase linearly as the fuel cell power plant current output increases, so that air-bleed will increase/decrease as required in a passive manner in response to increase/decrease in flow from the cathode air pump 31 as its speed is varied to suit the power output of the fuel cell power plant.

Another feature of the present invention is that the air bleed is more thoroughly mixed with the fuel by being introduced upstream of the recycle drive (pump, ejector or other pressure-increasing device, as the case may be). In typical installations, the length of the flow passageway between the introduction of the air into the recycle loop and the anode flow fields themselves is likely to be longer than conventional prior art bleeds that are provided directly to the anode flow field inputs, thereby assuring a greater mix of the air with the fuel.

Additionally, the hydrogen in the recycle loop is generally saturated with water and is diluted (e.g., with nitrogen from cross-over from the cathode in the stack). Therefore, introducing the air bleed into the recycle loop is safer than introducing it into the dry and undiluted hydrogen from the source.

1. A fuel cell power plant (9) comprising:
a stack (11) of fuel cells, each of the fuel cells including anode flow fields (13) having fuel inlets (18) and fuel exhaust (23), through which fuel reactant gas flows, and cathode flow fields (14) having air inlets (30), through which oxidant reactant gas flows;
a fuel recycle loop (24, 25) interconnected between the fuel exhaust of said stack of fuel cells and the fuel inlets;
a fuel source (20) connected to the fuel inlets;
an air supply device (31) connected to the air inlets;
characterized by:
a fluid connection between said fuel exhaust and a source of air (31, 45, 48).

2. A fuel cell power plant according to claim 1 further characterized by:
said fluid connection including a valve (41) between said source of air (31, 45, 48) and said fuel exhaust (23).

3. A fuel cell power plant according to claim 1 further characterized by:
said fluid connection including a flow control device (41) disposed between said source of air (31, 45, 48) and said fuel exhaust (23).

4. A fuel cell power plant according to claim 3 further characterized by:
said flow control device being a valve (41).

5. A fuel cell power plant according to claim 1 further characterized by:
said source of air comprising said air supply device (31).

6. A fuel cell power plant according to claim 1 further characterized by:
said source of air comprising a low pressure, low flow pump (48).

7. A fuel cell power plant according to claim 1 further characterized by:
said fluid connection including flow control device (41) disposed between said source of air (31, 45, 48) and said fuel exhaust (23).

8. A fuel cell power plant according to claim 1 further characterized by:
said source of air comprising a low flow, low pressure air pump (48) disposed in said fluid connection between said cathode air supply device (31) and said fuel exhaust (23).

9. A method in a fuel cell power plant (9) comprising a stack (11) of fuel cells, each of the fuel cells including anode flow fields (13) having fuel inlets (18) and fuel exhaust (23), through which fuel reactant gas flows, and cathode flow fields (14) having air inlets (30), through which oxidant reactant gas flows, a fuel recycle loop (24, 25) interconnected between the fuel exhaust of said stack of fuel cells and the fuel inlets, a fuel source (20) connected to the fuel inlets, an air supply device (31) connected to the air inlets,
characterized by:
connecting said fuel exhaust to a source of air (31, 45, 48).

10. A method according to claim 9 further characterized by:
connecting said source of air (31, 45, 48) to said fuel exhaust (23) through a flow restrictor (41).

11. A method according to claim 10 further characterized by:
the flow restrictor comprising a valve (41).

12. A method according to claim 9 further characterized by:
connecting said fuel exhaust (23) to said air supply device (31).

13. A method according to claim 9 further characterized by:
connecting said fuel exhaust (23) to a low pressure, low flow pump (48).

14. A method according to claim 9 further characterized by:
connecting said source of air (31, 45, 48) to said fuel exhaust (23) through flow control means (41).

15. A method according to claim 9 further characterized by:
connecting said cathode air supply device (31) to said fuel exhaust (23) through a low flow, low pressure air pump (48).

16. A method according to claim 15 further characterized by:
connecting said low pressure, low flow pump (48) to said fuel exhaust (23) through flow control means (41).

17. A method of providing air-bleed to the fuel (13, 18) flow in a fuel cell power plant (9) characterized by:
injecting air (31, 45, 48) into a fuel recycle loop (23, 24) of the fuel cell power plant.

18. A method according to claim 17 further characterized by:
injecting air from a cathode air supply device (31) into the fuel recycle loop (23, 24) of the fuel cell power plant (9).

19. A method according to claim 17 further characterized by:
injecting air from a low flow, low pressure air pump (45) into the fuel recycle loop (23, 24) of the fuel cell power plant (9).

20. A method according to claim 17 further characterized by:
injecting air from a cathode air supply device (31) through a low flow, low pressure air pump (48) into the fuel recycle (23, 24) loop of the fuel cell power plant (9).
